(19) United States
(12) Patent Application Publication
(10) Pub. No.: US 2025/0139370 A1
(43) Pub. Date: May 1, 2025

(54) DOCUMENT ABSTRACTION ENGINE

(71) Applicant: CBRE, INC., Los Angeles, CA (US)

(72) Inventors: Ira Stevens, New Boston, NH (US); Surya Rebbapragada, Irving, TX (US); Sachin Raghunandana Peruri, Dallas, TX (US); Chandrasekhar Subramanya Venkata, Irving, TX (US); Shilpa Karra, Southlake, TX (US); Marlies Kovenock, Richmond, VA (US); William Hayes, Ponte Vedra, FL (US); Brooke Gary, Hickory Flat, MS (US); Gary Michael Kindler, London (GB); Vignesh Singaravelu, McKinney, TX (US)

(73) Assignee: CBRE, INC., Los Angeles, CA (US)

(21) Appl. No.: 18/498,926

(22) Filed: Oct. 31, 2023

(51) Int. Cl. G06F 40/295; G06F 40/284

(52) U.S. Cl. CPC G06F 40/295; G06F 40/284

(57) ABSTRACT

A computing system receives a document to be analyzed. The document is associated with a document type of a plurality of document types. The computing system determines the document type associated with the document. The computing system routes the document to a plurality of name entity recognition transformer models trained to identify a plurality of entities in the document. The plurality of name entity recognition transformer models extracts the plurality of entities from the document. For each word in the document, a multi-modal encoder-based transformer model determines a probability that the word is an entity based on output generated by the plurality of name entity recognition transformer models and the document. The computing system generates a summary of the document by arranging the plurality of entities in accordance with an ontology dedicated to the document type.

### TECHNICAL FIELD

Embodiments disclosed herein generally relate to systems and methods extracting data from a document.

### BACKGROUND

Leases and mortgages are traditionally documents that are written in archaic and often difficult to comprehend language. Because of the length of these documents, as well as the grammar and syntax used by the drafter, it is often difficult of individuals to identify key components of these documents.

### SUMMARY

In some embodiments, a method of processing a document is disclosed herein. A computing system receives a document to be analyzed. The document is associated with a document type of a plurality of document types. The computing system determines the document type associated with the document. The computing system routes the document to a plurality of name entity recognition transformer models trained to identify a plurality of entities in the document. The plurality of name entity recognition transformer models extracts the plurality of entities from the document. For each word in the document, a multi-modal encoder-based transformer model determines a probability that the word is an entity based on output generated by the plurality of name entity recognition transformer models and the document. The computing system generates a summary of the document by arranging the plurality of entities in accordance with an ontology dedicated to the document type.

In some embodiments, a non-transitory computer readable medium is disclosed herein. The non-transitory computer readable medium includes one or more sequences of instructions, which, when executed by a processor, causes a computing system to perform operations. The operations include receiving, by the computing system, a document to be analyzed. The document is associated with a document type of a plurality of document types. The operations further include determining, by the computing system, the document type associated with the document. The operations further include routing, by the computing system, the document to a plurality of name entity recognition transformer models trained to identify a plurality of entities in the document. The operations further include extracting, by the plurality of name entity recognition transformer models, the plurality of entities from the document. The operations further include, for each word in the document, determining, by a multi-modal encoder-based transformer model, a probability that the word is an entity based on output generated by the plurality of name entity recognition transformer models and the document. The operations further include generating, by the computing system, a summary of the document by arranging the plurality of entities in accordance with an ontology dedicated to the document type.

In some embodiments, a system is disclosed herein. The system includes a processor and a memory. The memory has programming instructions stored thereon, which, when executed by the processor, causes the system to perform operations. The operations include receiving a document to be analyzed. The document is associated with a document type of a plurality of document types. The operations further include determining the document type associated with the document. The operations further include routing the document to a plurality of name entity recognition transformer models trained to identify a plurality of entities in the document. The operations further include extracting, by the plurality of name entity recognition transformer models, the plurality of entities from the document. The operations further include, for each word in the document, determining, by a multi-modal encoder-based transformer model, a probability that the word is an entity based on output generated by the plurality of name entity recognition transformer models and the document. The operations further include generating a summary of the document by arranging the plurality of entities in accordance with an ontology dedicated to the document type.

### BRIEF DESCRIPTION OF THE FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 is a block diagram illustrating a computing environment, according to example embodiments of the present disclosure.

FIG. 2 is a block diagram illustrating document abstraction engine, according to example embodiments.

FIG. 3 illustrates an example document abstraction of a document, according to example embodiments.

FIG. 4 illustrates an example document abstraction of a document, according to example embodiments.

FIG. 5 is a block diagram illustrating an architecture of a custom multi-modal encoder based transformer, according to example embodiments.

FIG. 6 is a flow diagram illustrating a method of generating a document abstract, according to example embodiments.

FIG. 7 is an exemplary screenshot of an output generated by document abstraction engine, according to example embodiments.

FIG. 8A is a block diagram illustrating a computing device, according to example embodiments of the present disclosure.

FIG. 8B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

One or more techniques disclosed herein provide a document abstraction engine for analyzing and summarizing legal documents uploaded by end users. As those skilled in the art understand, often, legal documents, such as leases, mortgages, and amendments, are often length and drafted in a manner that often requires professional assistance to understand. Despite their importance and legal effect, key terms are often hidden or obfuscated within the document, leaving executors of the legal document on their own to search for and identify such key terms.

To improve this process, the present disclosure provides a document abstraction engine that extracts key information from legal documents. The document abstraction engine includes an ensemble of a variety of transformer architectures trained specifically for named entity recognition for these types of documents. In this manner, the document abstraction engine is able to provide end users with a summary or abstract of their legal documents, without requiring hours of analysis.

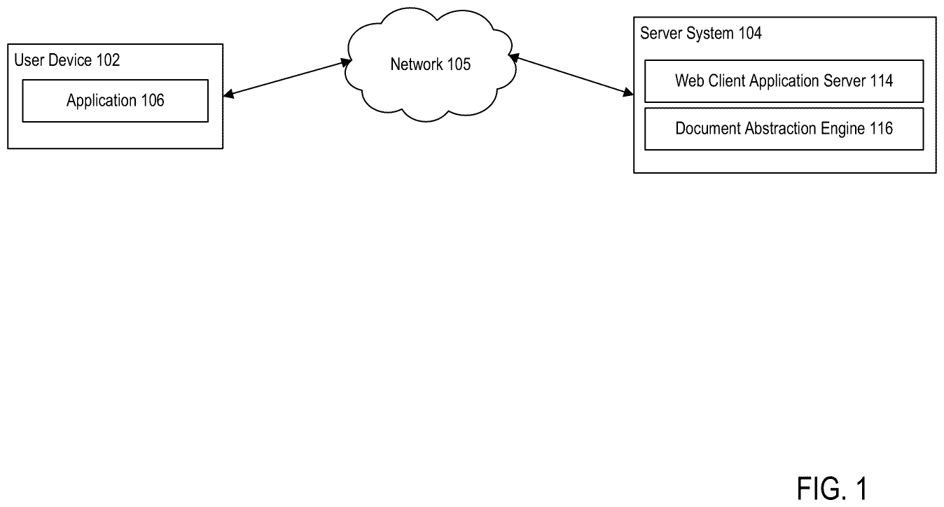

FIG. 1 is a block diagram illustrating a computing environment 100, according to example embodiments. As shown, computing environment 100 may include a user device 102 and a server system 104 communicating via network 105.

Network 105 may be representative of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be representative of the Internet, a private data network, virtual private network using a public network and/or other suitable connection(s) that enables components in computing environment 100 to send and receiving information between the components of computing environment 100.

User device 102 may be operated by a user. In some embodiments, user device 102 may represent devices of users that are associated with or subscribed to services offered by an entity associated with server system 104. In some embodiments, user device 102 may be representative of one or more computing devices, such as, but not limited to, a mobile device, a tablet, a personal computer, a laptop, a desktop computer, or, more generally, any computing device or system having the capabilities described herein.

User device 102 may include application 106. Application 106 may be representative of a web browser that allows access to a website or a stand-alone application. User device 102 may access application 106 to access one or more functionalities of server system 104. User device 102 may communicate over network 105 to request a webpage, for example, from web client application server 114 of server system 104. For example, user device 102 may be configured to execute application 106 to upload a document for analysis. For example, user device 102 may execute application 106 to provide server system 104 with a legal document, such as a lease, amendment, etc., for abstraction. In other words, user device 102 may execute application 106 for request analysis of a legal document, such that user device 102 may receive, as output from server system 104, an abstracted or summarized view of the uploaded legal document.

Server system 104 may include at least a web client application server 114 and document abstraction engine 116. Document abstraction engine 116 may be comprised of one or more software modules. The one or more software modules may be collections of code or instructions stored on a media (e.g., memory of server system 104) that represent a series of machine instructions (e.g., program code) that implements one or more algorithmic steps. Such machine instructions may be the actual computer code the processor of server system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Document abstraction engine 116 may be configured to receive, as input, a data file corresponding to a legal document, such as, but not limited to, a lease, an amendment, a mortgage statement, and the like. Document abstraction engine 116 may utilize a combination of natural language processing and machine learning techniques to summarize or “abstract” the information in the legal document, such that an end user may be provided with a list of terms associated with the legal document. For example, in the case of a lease, document abstraction engine 116 may receive, as input, a document file corresponding to the lease, and may generate, as output, a list of key terms, such as, but not limited to: property address, commencement date, end date, term, rent, security deposit, covered utilities, and the like.

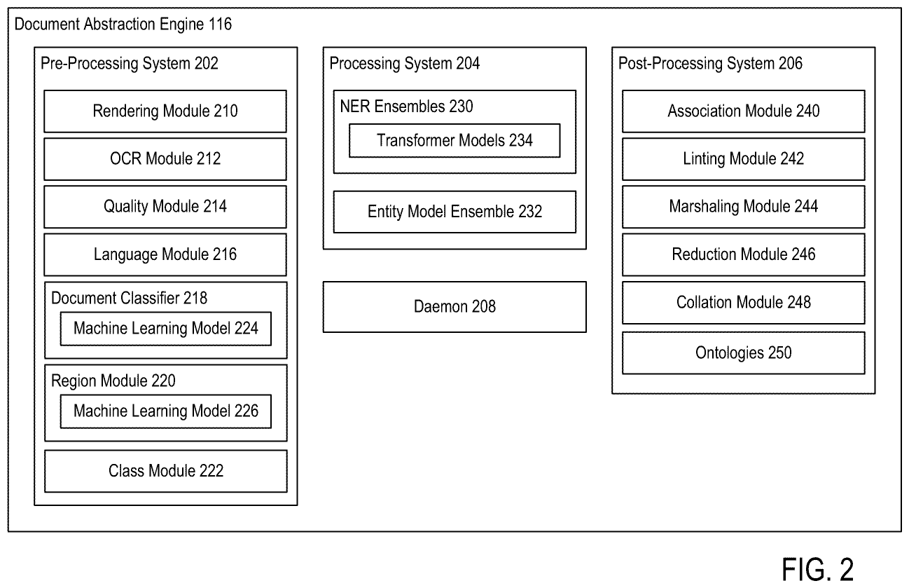

FIG. 2 is a block diagram illustrating document abstraction engine 116, according to example embodiments. As shown, document abstraction engine 116 may include one or more of a pre-processing system 202, an entity processing system 204, a post-processing system 206, and a daemon 208 facilitating movement of a document through a processing pipeline defined by pre-processing system 202, entity processing system 204, and post-processing system 206.

Pre-processing system 202 may be configured to perform one or more pre-processing steps on a received document prior to analysis. For example, as shown, pre-processing system 202 may include a rendering module 210, an optical character recognition module 212, a quality module 214, a language module 216, a document classifier 218, a region module 220, and a class module 222.

Rendering module 210 may be configured to receive a document for processing. The document may be one of a plurality of possible document types. For example, the document may take the form of one or more of a portable document format (PDF), Word document (.doc, .docx), hypertext markup language (HTML), OpenDocument Text (e.g., ODT), text file (e.g., .txt), and the like. In such examples, rendering module 210 may render the document into an image format on a page-by-page basis. In some embodiments, the document may already be in an image format. In such embodiments, the document may bypass rendering module 210.

Optical character recognition module 212 may be configured to perform optical character recognition on the rendered document. In some embodiments, optical character recognition module 212 may perform the optical character recognition locally. For example, optical character recognition module 212 may block the document content using one or more optical character recognition techniques. In some embodiments, optical character recognition module 212 may utilize a third party application programming interface (API) for the optical character recognition. The optical character recognition process may provide a text confidence value for each block in the document. The text confidence value may represent a likelihood that the recognized text in that block is the actual text for that block. In some embodiments, the optical character recognition process may also provide an indication of the language used in the document. Accordingly, in some embodiments, optical character recognition module 212 may generate a language confidence level per page.

Quality module 214 may be configured to determine the image quality of each page of the rendered document. In some embodiments, quality module 214 may determine the image quality of each page of the rendered document by determining a text confidence for each block in the rendered document and averaging them. Quality module 214 may determine an image quality for the whole document by averaging the average page text confidence across all pages. Similarly, in some embodiments, quality module 214 may determine a language confidence per page based on the language confidence values generated by or received by optical character recognition module 212. Quality module 214 may average the per page language confidence scores to determine the prevalent language used in the document.

Document classifier 218 may be configured to determine the type of document corresponding to the received document. As those skilled in the art understand, a legal document may have various components. For example, a lease packet may include the lease itself and amendments to the lease. Accordingly, document classifier 218 may be utilized to classify the document or section or component of the document. In some embodiments, document classifier 218 may apply a classifier to each page of the document to determine the onset of one of several document classes (e.g., leases or amendments). Such process may be performed to determine when a first document class ends (e.g., a lease) and a new document class begins (e.g., an amendment to the lease).

In some embodiments, to classify the types of documents present, document classifier 218 may utilize a machine learning model 224. Machine learning model 224 may be representative of a classification model. For example, machine learning model 224 may be representative of a fine-tuned discriminative transformer based on the Bidirectional Encoder Representations from Transformers (BERT) framework. Machine learning model 224 may be trained to determine the likelihood that any particular page represents the onset of a new document class. In some embodiments, the transformer architecture of machine learning model 224 may include a task-head that may be a dense layer with a softmax activation layer. The task-head may determine one of many possible classes associated with the document. Once each component of the document is classifier, the document can be separated into component parts.

Region module 220 may be configured to determine a region corresponding to each component of the document. As shown, region module 220 may include machine learning model 226. In some embodiments, machine learning model 226 may be representative of a fine-tuned discriminative transformer based on BERT. Machine learning model 226 may be trained for name entity recognition of property street, number, city and state, or province. In some embodiments, recognition may be done by performing a windowing technique. Once machine learning model 226 identifies the entities (e.g., property street, number, city and state, or province), region module 220 may provide the entities to a geolocation API. The geolocation API may determine the country corresponding to the property identified in the document. The determined country may assist in determining which downstream models to route the document for further processing.

Class module 222 may be configured to determine a document class corresponding to each component of the document. In some embodiments, class module 222 may determine the document class based on the results generated by document classifier 218. For example, the onset of a new document type within a file may be used as the document class.

Once the class, language, and or region of each document in the file is determined, daemon 208 may provide the document to appropriate models in processing system 204.

Processing system 204 may be configured to process each document type to identify entities within the documents of a file. An entity may broadly refer to a named token sequence of a particular class (e.g., street-name). As shown, processing system 204 may include named entity recognition ensembles 230 and entity model ensemble 232.

Named entity recognition ensembles 230 may be configured to classify a plurality of classes per region and document class. For example, the total number of distinct entities classified for all regions and document types may exceed 200 classes. Named entity recognition ensembles 230 may include a plurality of fine-tuned discriminator transformer models (hereinafter “transformer models 234” or singularly “transformer model 234”) based on BERT. Each transformer model 234 may be trained for named entity recognition. In some embodiments, each transformer model 234 may be limited to a threshold number of entities per model. For example, each transformer model 234 may be trained with no more than 20 entities per model. As those skilled in the art understand, the threshold number of entities per model may be less than 20 entities per model or greater than 20 entities per model. To provide a more robust classification system, in some embodiments, multiple transformer models 234 may be trained with the same entities. Such repeat training may assist in verifying the context of those entities, such as by altering the true negative training sets, thus improving the overall precision of named entity recognition ensembles 230.

In some embodiments, each transformer model 234 may be an ensemble of itself by using the joint probabilities of results from predictions of any single token. In some embodiments, the predictions may be generated by using a rolling 512 token window with a 64 token span. The joint probability of each token may be the product of the probabilities of all predictions.

Entity model ensemble 232 may be configured for named entity of the distinct entity labels identified by named entity recognition ensembles 230. In some embodiments, entity model ensemble 232 may be representative of a custom multi-modal encoder-based transformer with a dense softmax task head used for named entity recognition of the distinct entity labels. The outputs from transformer models 234 may be provided as input to named entity recognition ensemble 230 to determine the entity probabilities by word. For example, if for a particular windowed text of a document, there are two name entity recognition models that find the street address and only one finds the city, entity ensemble 232 may be configured to resolve the ambiguity of the street address and incorporate the city. In other words, the system may present entity model ensemble 232 with the results of the first and second named entity recognition along with the text window itself, and entity model ensemble 232 may be trained to respond with the likeliest street address and city found for that window.

Post-processing system 206 may be configured to process the outputs of processing system 204 to provide an abstraction or response to the uploader. Post-processing system 206 may generate its output based on one or more of document region, class, and target. As shown, post-processing system 206 may include an association module 240, linting module 242, marshaling module 244, reduction module 246, collation module 248, and ontologies 250. Association module 240, linting module 242, marshaling module 244, reduction module 246, and ontologies 250 may work in conjunction to generate the appropriate abstract for each document. For example, association module 240, linting module 242, marshaling module 244, and reduction module 246 may abstract documents by region, class, and target using ontologies 250 to roll up the given entities into the final field values.

Ontologies 250 may generally refer to a human readable configuration describing how entities are reduced into fields using various operations performed by association module 240, linting module 242, marshaling module 244, and reduction module 246. In some embodiments, ontologies may include a unique ontology file for each combination of region, document class, and abstraction target.

Generally, for each uploaded document, there is a set of entities that are extracted by named entity recognition ensembles 230 and entity model ensembles 232. The document itself may be composed of entities grouped by context. Each entity can have a class/name (e.g., identity), phrase, and confidence. The context may be used to indicate associated Entities. For example, the property street and city. The knowledge base may be initialized with the entities found by entity recognition ensembles 230 and entity model ensembles 232 and may be evaluated by applying ontologies 250.

An ontology 250 may be composed of semantics. Semantics may include a baseline confidence and sequence of operations. In some embodiments, the operations may include a reference operation to reference another field or entity by identity. An operation can have a child operation which would provide a result or results to the parent operation. A semantic can also be a primitive Type, i.e., one that may predefine association, linting, and marshaling functions to be applied to the entities. Semantics, when applied to the knowledge base, may establish new fields within that knowledge base named after the semantic identity. Fields may contain an optional value by type or a syntax using a common grammar, hints (i.e., how a human would determine a value if abstraction could not), and/or confidence level (i.e., the joint label and base confidence). In some embodiments, referencing an identity may result in multiple values, which can be grouped by the operations in various ways before evaluation. For example, operations may organize parameter values by a “pivot.” Exemplary pivots may include, but are not limited to, “Pivot-by-Context,” “Pivot-by-Identity,” and “Pivot-by-Structure.” Pivot-by-Context may cause the operation to be evaluated with parameter values having unique group-ids. Pivot-by-Identity may cause the operation to be evaluated with parameter values having the same class/name. Pivot-by-Structure may cause the operation to be evaluated with parameter values within the same structure.

Association module 240 may be configured to group tokens from the document as an instance of a primitive type and optional structure. In some embodiments, a primitive type may be defined by the token label and identified by ontologies 250. A primitive type may include multiple tokens in a sequence (e.g., “property-name”). Similarly, structure or structures may be defined by ontologies 250. Structures may identify which labels belong together. For example, a structure may define that “property-address” is composed of a number, street, city, state, and zip code.

In some embodiments, association module 240 may utilize a gated recurrent unit (GRU) recurrent neural network (RNN) to determine whether a sequence of entity labels is associated or related. For example, GRU RNN may be trained on all possible combinations of sequences of two entity labels to learn how to group entity label sequences. During inference, association module 240 may identify associated tokens by “walking” the sequences and grouping tokens predicted to be associated under a single group-id. For example, “number,” “street,” “city,” “state,” and “zip code” may be grouped under the group-id-“property address.”

In operation, association module 240 may provide the GRU RNN with the first two tokens of the sequence. Association module 240 may then provide the GRUI RNN with the predicted association of the last two tokens in the sequence and the next token in the sequence. This process may be repeated until the sequences is complete.

In some embodiments, association module 240 may generate an initial guess of entity determination using a determinist method. For example, association module 240 may walk the sequences of tokens and may associate the tokens by a single group id until the structure in which they are a member—as defined by ontologies 250—is filled or one of the members are repeated. For example, a property address would have one of the members repeated if the street token was repeated twice in a row as the sequence was walked. In another example, a property address would have one of the members repeated if the street, city, state were filled and another street token was identified in the sequence.

Linting module 242 may be configured to perform a recovery process following entity association. During the recovery process, linting module 242 may identify excluded tokens or incorrectly included tokens of a group and label. For example, in the context of a “property address,” a street name token may be present but the thoroughfare may be missing. Linting module 242 may also be configured to identify sequences of tokens that may belong to an incomplete instance or an entirely missing instance of a structure. For example, in a rent schedule for an apartment, linting module 242 may determine that the base rent for the second month of the year was excluded.

In some embodiments, linting module 242 may perform the recovery process using the primitive type of the label itself. For example, linting module 242 may utilize an autocorrect function defined by the primitive type assigned to the entity label within ontologies 250. In some embodiments, the autocorrect function may remove unnecessary tokens (e.g., ending punction) and may add any missing tokens (e.g., missing thoroughfare) according to the design of the type of label itself.

In some embodiments, such as when the portion of the document is a table, linting module 242 may perform a slightly different process. As those skilled in the art understand, tabled entities, such as base-rents or abatements, are typically read left-to-right, top-to-bottom, with each row usually containing a label that makes up a single instance of a structure (e.g., rent month and amount). When named entity recognition ensembles 230 and/or entity model ensemble 232 miss a value (e.g., they found rent month June but missed the rent amount for June), linting module 242 may autocorrect that value by adding the missed value under the correct group ID. To determine whether an entire entity is included or excluded, linting module 242 may analyze the document at the structure level as defined by ontologies 250. Such ontologies 250 may be specific to the structure of that document time. During this process, a table ID, row number, and column number are assigned such that the table may be reconstructed in its original layout.

In some embodiments, to detect the presence of a table, linting module 242 may utilize a machine learning model. For example, linting module 242 may utilize a fine-tune convolutional neural network model trained to identify the presence of tables in a document. Marshaling module 244 may be configured to arrange or assemble phrases by decoding the sequence of tokens-provided by each distinct label and group-ID-in accordance with the primitive type assigned to its label. For example, the token sequence grouped and labeled-“street name”—may have the primitive type-“USPS Street”-assigned within ontologies 250. During the recovery process discussed above, a token was missing such that autocorrection was used to detect and include the missing token (e.g., the thoroughfare). The primitive type may also define a particular grammar which may be applied to the autocorrected phrase that would transform the autocorrected phrase into a complete value. For example, “123 N Main Street South” where “123” is the USPS street number, “N” is the directional prefix, and the like.

In some embodiments, marshaling module 244 may use a language model for arranging or assembling phrases after autocorrection. For example, marshaling module 244 may use a language model when the rendered phrases are expected to reference or require a calculation of a value rather than declare it outright. In other words, marshaling module 244 may use a language model when the rendered phrases are relative phrases. Examples may include date indexing, such as, but not limited to “First Month” or “12 days after the commencement date.” The language model utilized by marshaling module 244 may be trained to translate phrases into a syntax of a common grammar such that, when evaluated against a local knowledge base, may transform the phrase into a value.

In some embodiments, the language model may be representative of a transformer architecture. For example, the language model may be a custom encoder-decoder transformer model trained on thousands of phrases. In some embodiments, the transformer architecture may include a large-vocabulary tokenizer and a generative transformer for a translation language. The encoder portion may allow for misspellings and poor sentence structure (e.g., mis-ordered words, missing words, extra words, and poor grammar). The decoder portion and task head may provide translation to the LL-regular (LLR) grammar. Such process may assist collation module 248, discussed below, to resolve references to values determined by other field.

During the arranging or assembling process, a knowledge base for the document may be established.

Reduction module 246 may be configured to transform multiple entities into an appropriate set of fields as defined by a developer. For example, property address (as a structure) may include a single street name as a field, which may be determined to be “1 Main Street” from an entity street-name with multiple instances (e.g., “1 main,” “one main st,” “man [sic] street,” etc.). For example, reduction module 246 may perform an iterative, bottom-up, application of operations to phrases of the same class to reduce them to a single phrase. In some embodiments, reduction module 246 may aggregate phrases of different classes into structural instance. For example, location (as a structure) may have two instances, each with a field, location-name (e.g., “suite 101” and “floor 2,” which were determined from the entities: “location-name” with instances “floor one,” “fl 1,” “suite,” “suite 101,” etc.

In some embodiments, reduction module 246 may further be configured to determine a confidence of the final field value. For example, reduction module 246 may calculate a joint confidence of the label from the evaluation performed by entity model ensemble 232 and the current confidence found by entity model ensemble for the instance. In some embodiments, the joint confidence may refer to a pre-determined model confidence (e.g., the metrics of the model when trained) of the label time the confidence of the instance found in the document being processed. For example, the street-name model confidence may be measured to be 0.84, but for the current value found, a confidence of 0.96 is correct. In such situation, joint confidence may be used to determine if it is more likely than not another instance of street-name (e.g., with a 0.8 confidence). Such metric is helpful when combining labels that are from different models and semantically similar, but not the same.

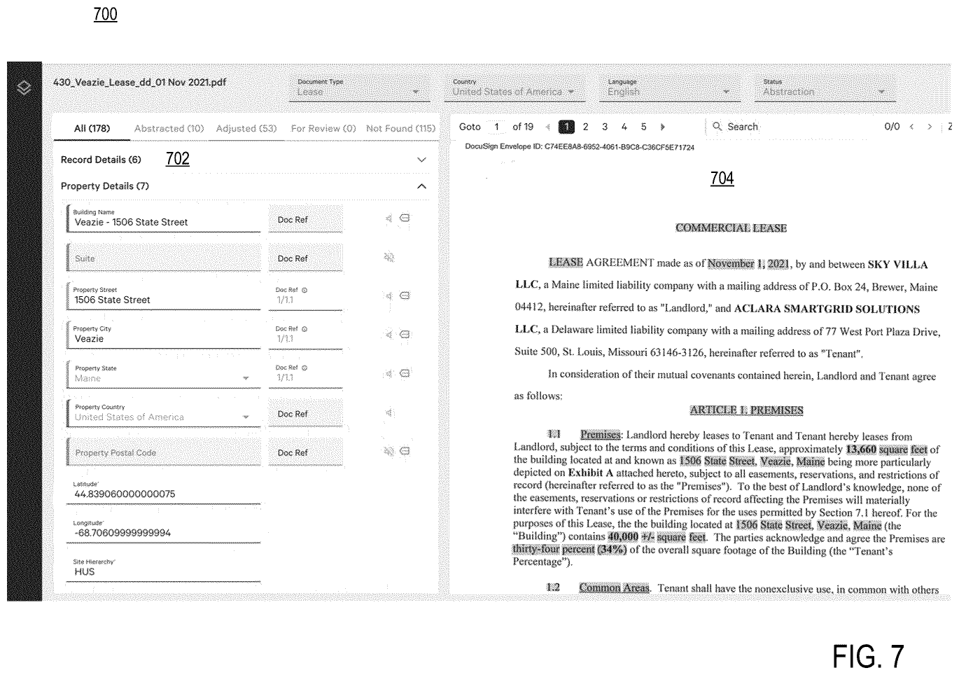

In some embodiments, reduction module 246 may be configured to provide a hint to the user when a final value cannot be determined. For example, if reduction module 246 cannot reduce a set of phrases to a discrete value, reduction module 246 may provide a human readable version as a “hint” so that the reader can determine a value themselves. An example of a “hint” may be seen in FIG. 7, discussed in further detail below.

Collation module 248 may be configurated to determine the final selection and arrangement of fields requested by the user. Collation module 248 may work in conjunction with marshaling module 244 to apply a common grammar (e.g., LLR grammar) to the fields to translate phrases into concrete values using the final state of the knowledge base.

As output, post-processing system 206 may generate a document abstraction to be provided to user device 102.

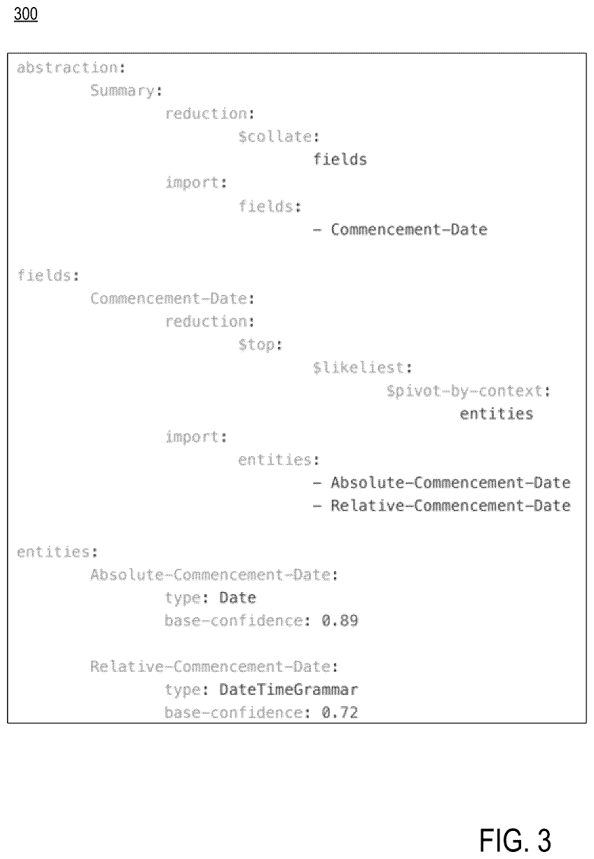

FIG. 3 illustrates an example document abstraction 300, according to example embodiments. In example document abstraction 300, two kinds of entities are extracted from the document—an absolute commencement date and a relative commencement date. The absolute commencement date is a phrase that may be parsed deterministically into a date type. The relative commencement date is a phrase that may reference another phrase and/or a computation and/or an index. In other words, collation module 248 may utilize the common grammar to translate the relative commencement date into lookup grammar. The semantic definition for these entities may include the type and base-confidence for the entity. The type definition may provide or define the operations performed by linting module 242 and marshaling module 244.

Note, two kinds of entities may have multiple phrases listed for each. For example, the document may repeat the commencement date of the agreement several times. Because there should only be one commencement date for each lease, post-processing system 206 may resolve all of the instances to the most likely one using, for example, reduction module 246. To perform such process, reduction module 246 may leverage the semantic definition int the fields section to resolve all instance to the likely one. For example, reduction module 246 may take all instance of both the absolute commencement date and the relative commencement date, i.e., the entities, and may group them by group id (e.g., $pivot-by-context), may calculate the likeliest group (e.g., $likeliest), and then may select the most likely one within that group (e.g., $top).

As output, post-processing system 206 may create a summary section which may only include the field-Commencement-Date.

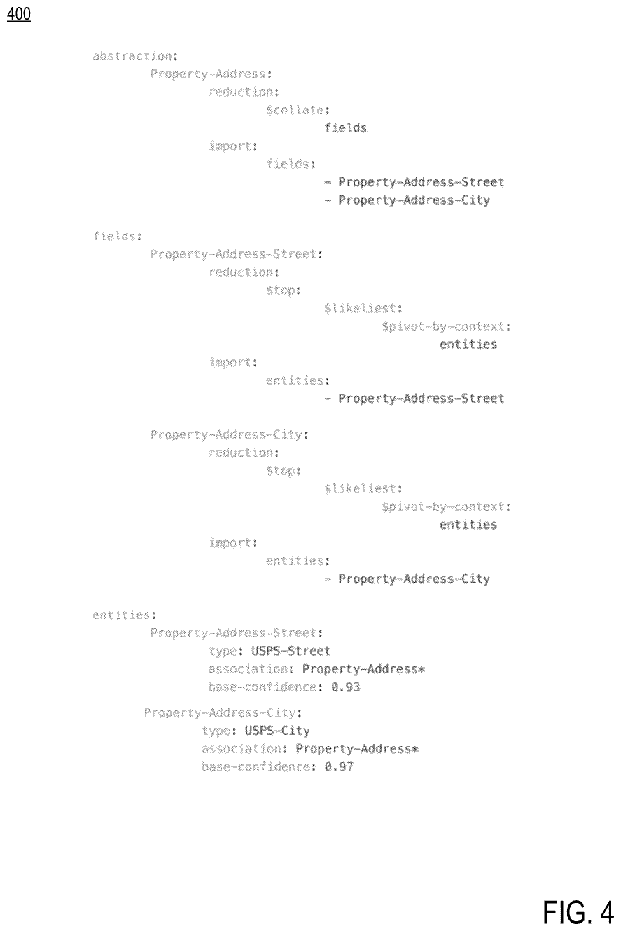

FIG. 4 illustrates an example document abstraction 400, according to example embodiments. In example document abstraction 400, the document may contain multiple property addresses, each with a street and city. Post-processing system 206 may analyze all instance of the street and city. In some embodiments, association module 240 may apply determine a relationship between the entities, i.e., “property-address,” in order to obtain the correct group-IDs. Linting module 242 and marshaling module 244 may then be deployed to arrange the tokens (e.g., USPS-Street and USPS-City). Finally, collation module 248 may arrange the most likely city and street into a single property address.

As those skilled in the art understand, because the document (e.g., a lease or mortgage) typically only refers to a single property address, such process will may yield the likeliest street and city—not as a structure—but individually.

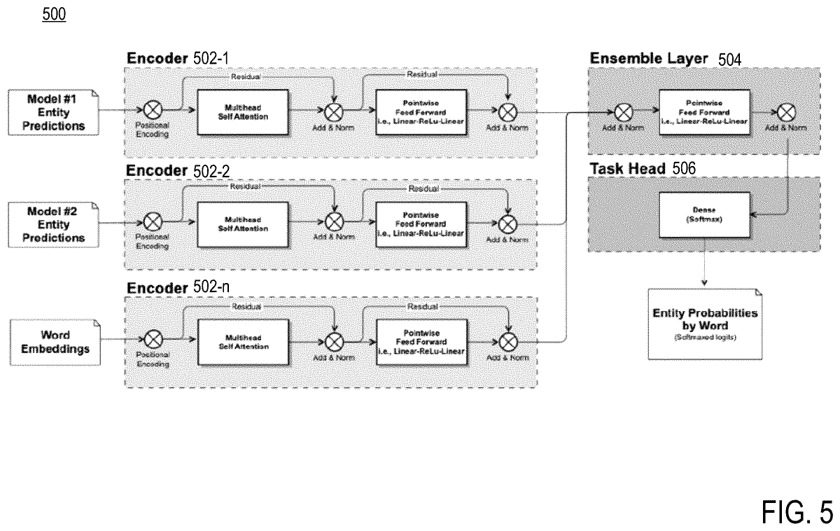

FIG. 5 is a block diagram illustrating an architecture of the custom multi-modal encoder based transformer (hereinafter “transformer 500”) used by entity model ensemble 232, according to example embodiments.

As shown, transformer 500 may include a plurality of encoders 502-1 to 502-n (generally “encoder 502”), an ensemble layer 504, and a task head 506. Each encoder 502 may include a position encoding layer, a multi-head self attention layer, a pointwise feed forward layer, and a layer-normalization. As shown, each encoder 502 may receive, as input, output from each of the plurality of models utilized by named entity recognition ensembles 230. Additionally, one encoder 502 (e.g., encoder 502-n) may receive, as input, the word embeddings corresponding to the document.

Ensemble layer 504 may include at least a pointwise feed forward layer and one or more add and normalization layers. Task head 506 may be representative of a dense softmax task head. For example, task head 506 may be a dense softmax task head used for named entity recognition of the distinct entity labels.

As shown, as output, transformer 500 may generate entity probability by word. For example, given the context:
model #1 entity predictions, “O Street Street Street O City”
model #2 entity predictions, “O Street O O O”
word embeddings, “at 2 main st, Summerville” transformer 500 may generate, as output, “O Street Street Street O City,” where “O” is the label for “other“ ” (i.e., ignore). Additionally, since each label in the phrase has a corresponding confidence, in some embodiments, “probability by word” may refer to the corresponding label confidence per word of the original word embedding.

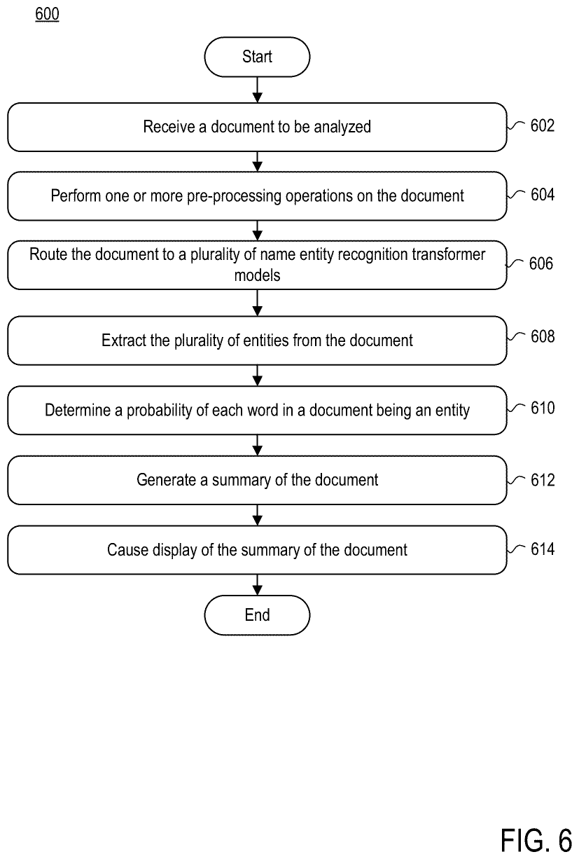

FIG. 6 is a flow diagram illustrating a method 600 of generating a document abstract, according to example embodiments. Method 600 may begin at step 602.

At step 602, server system 104 may receive a document to be analyzed. For example, a user via user device 102 may execute application 106 to server system 104 for analysis. In some embodiments, the document may be representative of a legal document, such as a lease, amendment to a lease, mortgage, amendment to a mortgage, etc.

At step 604, server system 104 may perform one or more pre-processing operations on the document. In some embodiments, pre-processing system 202 may perform one or more pre-processing steps on a received document prior to analysis. For example, in those embodiments in which the document is not in an image format, rendering module 210 may render the document into a plurality of images on a page-by-page basis. In some embodiments, optical character recognition module 212 may perform optical character recognition on the rendered document. In some embodiments, quality module 214 may determine the image quality of each page of the rendered document.

At step 606, server system 104 may route the document to a plurality of name entity recognition transformer models. In order to route the document to the correct plurality of name entity recognition transformer models, pre-processing system 202 may determine a type or types of document classes present in the document and/or a region associated with the document. For example, document classifier 218 may determine the type or types of document classes in the rendered document. In some embodiments, document classifier 218 may use a fine-tuned discriminative transformer to make this determination. In some embodiments, region module 220 may determine a region of each component or document class present in the rendered document. For example, region module 220 may utilize a machine learning model trained for entity recognition of property street, number, city, state, or province. Based on this information, region module 220 may interact with a geolocation API to determine the country to region corresponding to the property identified in the rendered document. Based on the document type and the region associated with the document, server system 104 may route the rendered document to the appropriate models for further analysis.

At step 608, server system 104 may extract the plurality of entities from the document. For example, a subset of transformer models in named entity recognition ensembles 230 may identify or extract entities from the document. Each transformer model may be trained for named entity recognition.

At step 610, server system 104 may determine a probability of each word in the document being an entity. For example, based on the outputs from transformer models 234, named entity recognition ensemble 230 may probability of each word in the document being an entity. In some embodiments, entity recognition ensemble 230 may employ a multi-modal encoder-based transformer to perform such analysis. determine the entity probabilities by word.

At step 612, server system 104 may generate a summary of the document. For example, post-processing system 206 may generate a summary or abstract of the document by arranging the plurality of entities in accordance with ontologies 250 dedicated to the document type.

At step 614, server system 104 may cause display of the summary of the document. For example, server system 104 may cause display of the summary of the document in application 106 executing on user device 102.

FIG. 7 is an exemplary screenshot 700 of an output generated by document abstraction engine 116, according to example embodiments. As shown screenshot 700 may include a summary section 702 and a document section 704. Summary section 702 may include an abbreviated summary or abstract of the document shown in document section 704. For example, the outputs shown via summary section 702 were generated using document abstraction engine 116. Document section 704 includes the original document that was used to generate the summary in summary section 702. As shown, the entities that were detected by processing system 204 are highlighted or emphasized.

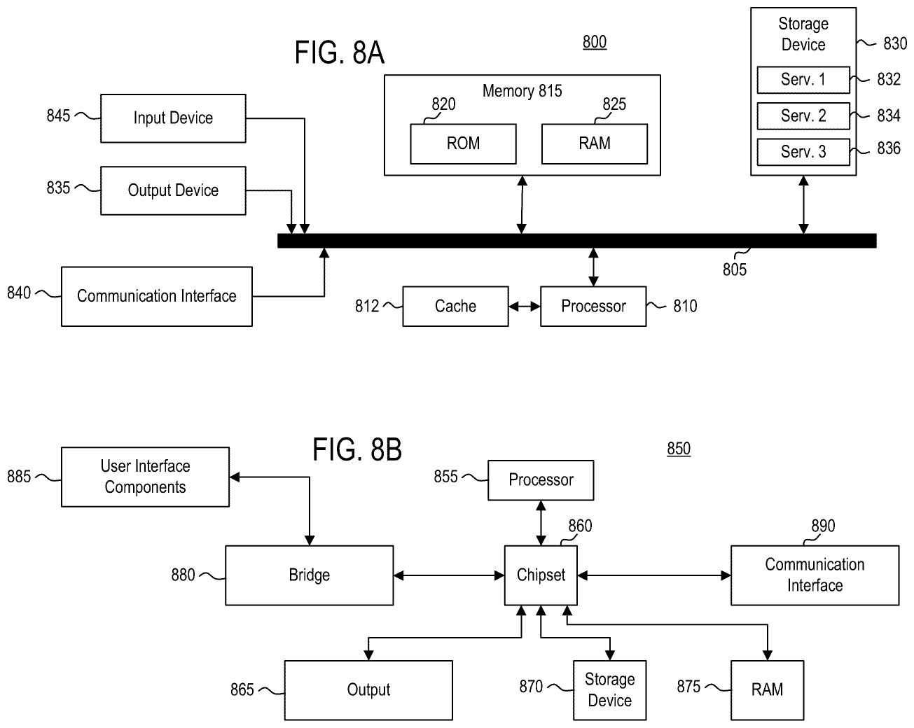

FIG. 8A illustrates a system bus architecture of computing system 800, according to example embodiments. System 800 may be representative of at least user device 102. One or more components of system 800 may be in electrical communication with each other using a bus 805. System 800 may include a processing unit (CPU or processor) 810 and a system bus 805 that couples various system components including the system memory 815, such as read only memory (ROM) 820 and random-access memory (RAM) 825, to processor 810.

System 800 may include a cache of high-speed memory connected directly with, in close proximity to, or integrated as part of processor 810. System 800 may copy data from memory 815 and/or storage device 830 to cache 812 for quick access by processor 810. In this way, cache 812 may provide a performance boost that avoids processor 810 delays while waiting for data. These and other modules may control or be configured to control processor 810 to perform various actions. Other system memory 815 may be available for use as well. Memory 815 may include multiple different types of memory with different performance characteristics. Processor 810 may include any general-purpose processor and a hardware module or software module, such as service 1 832, service 2 834, and service 3 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction with the computing system 800, an input device 845 may represent any number of input mechanisms, such as a microphone for speech, a touch-sensitive screen for gesture or graphical input, keyboard, mouse, motion input, speech and so forth. An output device 835 may also be one or more of a number of output mechanisms known to those of skill in the art. In some instances, multimodal systems may enable a user to provide multiple types of input to communicate with computing system 800. Communications interface 840 may generally govern and manage the user input and system output. There is no restriction on operating on any particular hardware arrangement and therefore the basic features here may easily be substituted for improved hardware or firmware arrangements as they are developed.

Storage device 830 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 825, read only memory (ROM) 820, and hybrids thereof.

Storage device 830 may include services 832, 834, and 836 for controlling the processor 810. Other hardware or software modules are contemplated. Storage device 830 may be connected to system bus 805. In one aspect, a hardware module that performs a particular function may include the software component stored in a computer-readable medium in connection with the necessary hardware components, such as processor 810, bus 805, output device 835 (e.g., display), and so forth, to carry out the function.

FIG. 8B illustrates a computer system 850 having a chipset architecture that may represent user device 102. Computer system 850 may be an example of computer hardware, software, and firmware that may be used to implement the disclosed technology. System 850 may include a processor 855, representative of any number of physically and/or logically distinct resources capable of executing software, firmware, and hardware configured to perform identified computations. Processor 855 may communicate with a chipset 860 that may control input to and output from processor 855.

In this example, chipset 860 outputs information to output 865, such as a display, and may read and write information to storage device 870, which may include magnetic media, and solid-state media, for example. Chipset 860 may also read data from and write data to storage device 875 (e.g., RAM). A bridge 880 for interfacing with a variety of user interface components 885 may be provided for interfacing with chipset 860. Such user interface components 885 may include a keyboard, a microphone, touch detection and processing circuitry, a pointing device, such as a mouse, and so on. In general, inputs to system 850 may come from any of a variety of sources, machine generated and/or human generated.

Chipset 860 may also interface with one or more communication interfaces 890 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 855 analyzing data stored in storage device 870 or storage device 875. Further, the machine may receive inputs from a user through user interface components 885 and execute appropriate functions, such as browsing functions by interpreting these inputs using processor 855.

It may be appreciated that example systems 800 and 850 may have more than one processor 810 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method of processing a document, comprising:
receiving, by a computing system, a document to be analyzed, the document associated with a document type of a plurality of document types;
determining, by the computing system, the document type associated with the document;
routing, by the computing system, the document to a plurality of name entity recognition transformer models trained to identify a plurality of entities in the document;
extracting, by the plurality of name entity recognition transformer models, the plurality of entities from the document;
for each word in the document, determining, by a multi-modal encoder-based transformer model, a probability that the word is an entity based on output generated by the plurality of name entity recognition transformer models and the document; and
generating, by the computing system, a summary of the document by arranging the plurality of entities in accordance with an ontology dedicated to the document type.

2. The method of claim 1, further comprising:
causing, by the computing system, display of the summary of the document.

3. The method of claim 2, wherein causing, by the computing system, display of the summary of the document further comprises:
causing display of the document side-by-side with the summary of the document.

4. The method of claim 1, wherein generating, by the computing system, the summary of the document by arranging the plurality of entities in accordance with the ontology dedicated to the document type comprises:
grouping entities in the document based on primitive type and structure defined by the ontology.

5. The method of claim 4, grouping the plurality of entities in the document based on the primitive type and the structure defined by the ontology comprises:
determining whether a sequence of entities is associated or related; and
grouping the sequence of entities under a single identifier.

6. The method of claim 1, wherein generating, by the computing system, the summary of the document by arranging the plurality of entities in accordance with the ontology dedicated to the document type comprises:
performing a recovery process on the plurality of entities by determining whether any tokens were excluded or incorrectly included in a group of entities.

7. The method of claim 1, wherein generating, by the computing system, the summary of the document by arranging the plurality of entities in accordance with the ontology dedicated to the document type comprises:
assembling phrases in accordance with a primitive type assigned to labels of tokens associated with the plurality of entities.

8. A non-transitory computer readable medium comprising one or more sequences of instructions, which, when executed by a processor, causes a computing system to perform operations, comprising:
receiving, by the computing system, a document to be analyzed, the document associated with a document type of a plurality of document types;
determining, by the computing system, the document type associated with the document;
routing, by the computing system, the document to a plurality of name entity recognition transformer models trained to identify a plurality of entities in the document;
extracting, by the plurality of name entity recognition transformer models, the plurality of entities from the document;
for each word in the document, determining, by a multi-modal encoder-based transformer model, a probability that the word is an entity based on output generated by the plurality of name entity recognition transformer models and the document; and
generating, by the computing system, a summary of the document by arranging the plurality of entities in accordance with an ontology dedicated to the document type.

9. The non-transitory computer readable medium of claim 8, further comprising:
causing, by the computing system, display of the summary of the document.

10. The non-transitory computer readable medium of claim 9, wherein causing, by the computing system, display of the summary of the document further comprises:
causing display of the document side-by-side with the summary of the document.

11. The non-transitory computer readable medium of claim 8, wherein generating, by the computing system, the summary of the document by arranging the plurality of entities in accordance with the ontology dedicated to the document type comprises:
grouping entities in the document based on primitive type and structure defined by the ontology.

12. The non-transitory computer readable medium of claim 11, grouping the plurality of entities in the document based on the primitive type and the structure defined by the ontology comprises:
determining whether a sequence of entities is associated or related; and
grouping the sequence of entities under a single identifier.

13. The non-transitory computer readable medium of claim 8, wherein generating, by the computing system, the summary of the document by arranging the plurality of entities in accordance with the ontology dedicated to the document type comprises:
performing a recovery process on the plurality of entities by determining whether any tokens were excluded or incorrectly included in a group of entities.

14. The non-transitory computer readable medium of claim 8, wherein generating, by the computing system, the summary of the document by arranging the plurality of entities in accordance with the ontology dedicated to the document type comprises:
assembling phrases in accordance with a primitive type assigned to labels of tokens associated with the plurality of entities.

15. A system comprising:
a processor; and
a memory having programming instructions stored thereon, which, when executed by the processor, causes the system to perform operations comprising:
receiving a document to be analyzed, the document associated with a document type of a plurality of document types;
determining the document type associated with the document;
routing the document to a plurality of name entity recognition transformer models trained to identify a plurality of entities in the document;
extracting, by the plurality of name entity recognition transformer models, the plurality of entities from the document;
for each word in the document, determining, by a multi-modal encoder-based transformer model, a probability that the word is an entity based on output generated by the plurality of name entity recognition transformer models and the document; and
generating a summary of the document by arranging the plurality of entities in accordance with an ontology dedicated to the document type.

16. The system of claim 15, wherein the operations further comprise:
causing display of the summary of the document.

17. The system of claim 15, wherein generating the summary of the document by arranging the plurality of entities in accordance with the ontology dedicated to the document type comprises:
grouping entities in the document based on primitive type and structure defined by the ontology.

18. The system of claim 17, grouping the plurality of entities in the document based on the primitive type and the structure defined by the ontology comprises:
determining whether a sequence of entities is associated or related; and
grouping the sequence of entities under a single identifier.

19. The system of claim 15, wherein generating the summary of the document by arranging the plurality of entities in accordance with the ontology dedicated to the document type comprises:
performing a recovery process on the plurality of entities by determining whether any tokens were excluded or incorrectly included in a group of entities.

20. The system of claim 15, wherein generating the summary of the document by arranging the plurality of entities in accordance with the ontology dedicated to the document type comprises:
assembling phrases in accordance with a primitive type assigned to labels of tokens associated with the plurality of entities.
